(19) United States
(12) Patent Application Publication
(10) Pub. No.: US 2026/0316923 A1
(43) Pub. Date: Oct. 15, 2026

(54) AIRCRAFT FOR PERSONAL USE OR DRONE, WITH SYSTEM FOR GENERATING DIRECTIONAL AND/OR THRUST JETS THAT USES ELECTROMAGNETIC INJECTORS SUPPLIED BY COMMON RAIL, AND SYSTEM FOR GENERATING JETS USED THEREIN

(71) Applicant: Interactive Fully Electrical Vehicles S.r.l., La Loggia (Torino) (IT)

(72) Inventors: Pietro PERLO, Torino (IT); Davide PENSERINI, Torino (IT)

(73) Assignee: Interactive Fully Electrical Vehicles S.r.l., La Loggia (Torino) (IT)

(21) Appl. No.: 19/485,566

(22) PCT Filed: Apr. 30, 2024
(86) PCT No.: PCT/IB2024/054190

§ 371 Date: Nov. 18, 2025

(30) Foreign Application Priority Data
May 19, 2023 (IT) 102023000010134

(51) Int. Cl. B64C 15/14; B64C 1/06; B64C 11/00; B64C 27/20; B64C 27/26; B64C 27/82; B64C 39/08; B64D 27/30; B64D 31/00; B64D 37/00; B64D 37/28; B64U 10/25; B64U 20/70; B64U 30/26; B64U 50/14; B64U 50/15; B64U 50/18; B64U 50/19; F02K 1/00

(52) U.S. Cl. CPC B64C 15/14; B64C 1/061; B64C 11/001; B64C 27/20; B64C 27/26; B64C 27/82; B64C 39/08; B64D 27/30; B64D 31/00; B64D 37/005; B64D 37/28; B64U 10/25; B64U 20/70; B64U 30/26; B64U 50/14; B64U 50/15; B64U 50/18; B64U 50/19; F02K 1/002; B64C 2027/8227

(57) ABSTRACT

An aircraft has a plurality of nozzles distributed along front wings and in the rear part of the aircraft, for emission of directional jets for control of the altitude of the aircraft in flight, and/or of thrust jets designed to provide additional lift and/or additional thrust to the aircraft. Each nozzle includes a nozzle chamber and an outlet mouth. A system for generating jets has a system for supplying pressurized fuel to the chambers of the nozzles, and a system for supplying combustion-supporting fluid to the chambers of the nozzles. The fuel-supply system includes a plurality of driven injector devices each associated to a nozzle, and a common rail that receives fuel from the pump and supplies it to the injector devices. An electronic controller keeps the pressure in the common rail within a range of values and drives the injector devices to inject pressurized fuel into the chamber of each nozzle to obtain a mixture with the fluid that gives rise to combustion which produces an explosion that generates a jet of fluid at outlet from the nozzle.

### FIELD OF THE INVENTION

The present invention relates to an aircraft for personal use or a drone, of the type comprising:
a load-bearing structure, defining a central body with front wings and rear wings; and
a plurality of annular propellers, supported in rotation by the load-bearing structure about substantially vertical axes, with reference to the condition where the aircraft is resting on the ground, and located in the front wings and in the rear wings of the aircraft, for sustaining the aircraft in flight, and at least one annular propeller supported in rotation by a tail of the central body about an axis substantially parallel to the longitudinal direction of the aircraft, to cause the aircraft to advance in flight,
wherein each annular propeller comprises a rotor ring carrying blades that extend radially from the body of the rotor ring towards the axis of the rotor ring; and
wherein each rotor ring is driven via a belt transmission by an electric motor mounted on the load-bearing structure about an axis parallel to, and set at a distance from, the axis of the rotor ring.

### PRIOR ART

An aircraft of the type referred to above has been described in the international patent application WO 2022/200883A1, filed in the name of the present applicant, and in the document US 2022/242562A1, which is also filed in the name of the present applicant.

With the intent of further improving the above aircraft, the present applicant has conducted studies and research with reference in particular to provision on the aircraft of directional and/or thrust jets aimed at drastically improving the manoeuvrability of the aircraft in flight and/or at producing additional lift and/or thrust.

At the same time, the present applicant has set himself the target of solving the aforesaid problem with a system that would prove extremely efficient and reliable.

On the basis of the studies carried out, the present applicant has moreover widened the sphere of the possible applications of interest, aiming at identifying a system for generating directional and/or thrust jets that would also be suited to being used not only on aircraft for personal use (the so-called Personal Air Vehicle—PAV), but also on drones or vehicles of any other type, in particular watercraft.

A system for generating jets of the type referred to in the preamble of claim 6 is known from the document CN 109 630 316 A.

### Object of the Invention

Consequently a specific object of the present invention is to provide an aircraft for personal use or a drone of the type referred to at the start of the present description, equipped with a system for generating directional and/or thrust jets that is extremely efficient and reliable and at the same time is relatively simple and inexpensive.

More in general, an object of the invention is to provide a system for generating directional and/or thrust jets configured for being used, by itself or as support to rotating systems, not only in aircraft or drones, but also in vehicles of some other type, for example in watercraft.

Yet a further object of the invention is to provide a system for generating directional and/or thrust jets configured for enabling use of the jets in an extremely flexible way in order to obtain, in the various conditions of use, whether by itself or as support to rotating systems, both a high manoeuvrability of the aircraft and additional lift and/or thrust.

With reference to the specific application on an aircraft for personal use or on a drone, an object of the invention is also to provide an aircraft with a structure and configuration suited to using in the most efficient way possible the directional and/or thrust jets of the system according to the invention.

In particular, an object of the invention is to provide a load-bearing structure for the aircraft that presents good characteristics of strength and lightness.

### SUMMARY OF THE INVENTION

With a view to achieving the aforesaid objects, according to a first aspect of the invention, the subject thereof is an aircraft for personal use or a drone that presents the characteristics specified in claim 1.

The aforesaid system for supplying fuel, which includes the fuel tank, the high-pressure pump, and the common rail for supplying fuel to the electromagnetically driven injector devices, is substantially built according to the technology known in the field of fuel-injection systems for diesel engines. The technology in this field has achieved a high level of development and reliability and can thus be advantageously used, according to the intuition of the present inventors, in an altogether new way in order to generate directional and/or thrust jets that can be used, in the case of the application described herein, on an aircraft for personal use or on a drone.

Beyond the specific application to an aircraft, however, the subject of the invention is also the system for generating jets taken in itself that can be used both on an aircraft and on vehicles of some other type, for example also on watercraft, according to what is specified in the annexed claim 6.

In a preferred embodiment, the fuel is for example constituted by ammonia, although not excluded is the use of other fuels, such as diesel, hydrogen, and methane, or mixtures of such fuels. The combustion-supporting fluid is air or oxygen. In one example, in addition to the fuel supplied by the common rail (for example, ammonia) it is also envisaged to supply hydrogen directly to the nozzles.

In a further example, the system moreover comprises a micro-electrolizer configured for generating hydrogen and oxygen from water. Oxygen is used as combustion-supporting fluid, which is brought to the necessary pressure by a compressor, whereas hydrogen is used as additional fuel, supplied directly to the chambers of the nozzles. Since the various nozzles must be activatable selectively to obtain the desired corrections in attitude of the aircraft, just as the electromagnetic injectors are controlled selectively, also the connection of the chambers of the nozzles to the air or oxygen supply envisages a system of valves that enables selective supply of the supporter of combustion to one or more nozzles. The aircraft constituting the preferred application of the system for generating jets presents moreover, according to the invention, a series of further innovative and advantageous characteristics, which will be described in detail hereinafter.

### DETAILED DESCRIPTION OF THE INVENTION

Some embodiments of the invention will be described in detail hereinafter, with reference to the annexed drawings, which are provided purely by way of non-limiting example and in which:

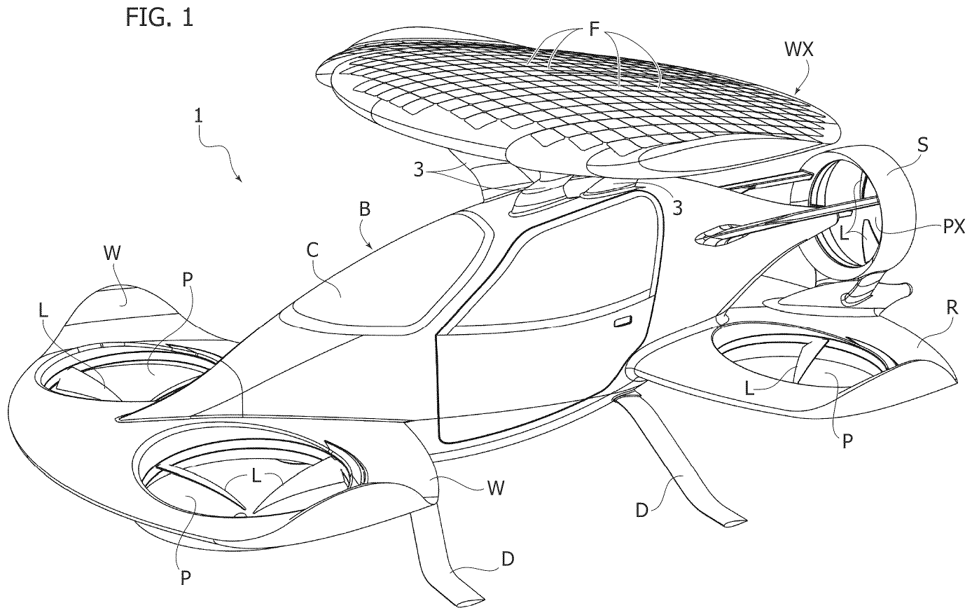

FIG. 1 is a perspective view of a personal air vehicle (PAV) according to the present invention;

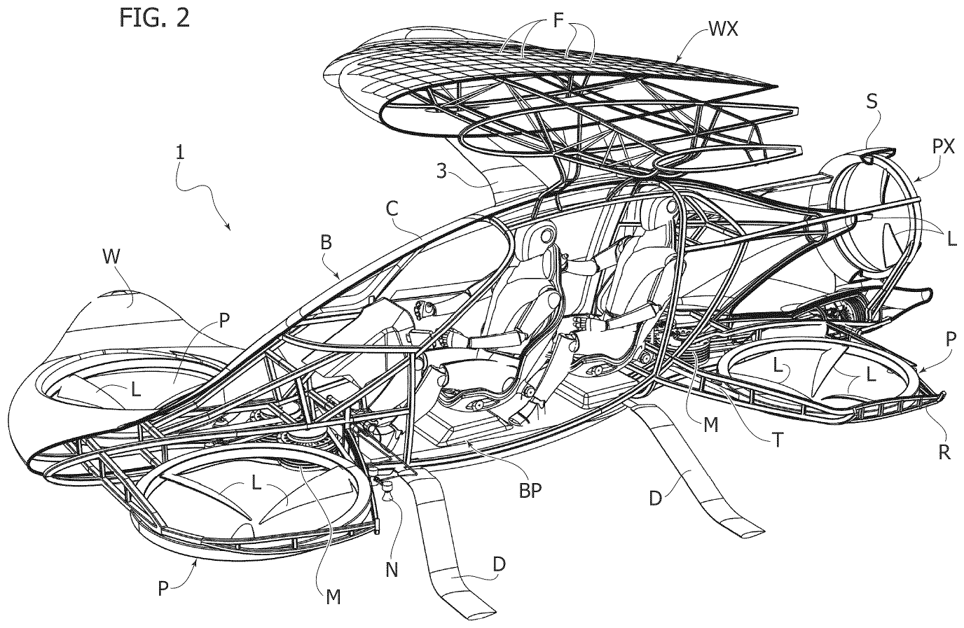

FIG. 2 is a further perspective view of the PAV of FIG. 1 that shows in see-through view the system for driving the annular propellers (rotors) with which the aircraft is provided;

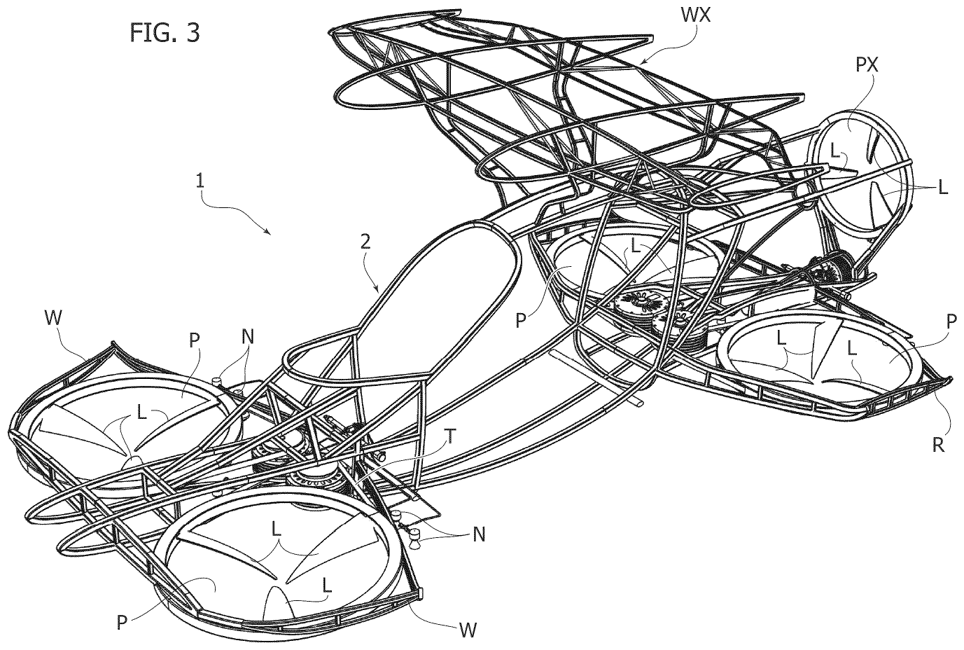

FIG. 3 is a further perspective view of the PAV of FIGS. 1 and 2 that shows the load-bearing structure of the aircraft, in the form of lattice structure made of high-strength steel, the aerodynamic surfaces of the aircraft being defined by steel sheets rigidly connected to the lattice structure, the internal cavities of the aerodynamic surfaces being preferably filled with spongy material, having high thermal and electrical conductivity, preferably graphene;

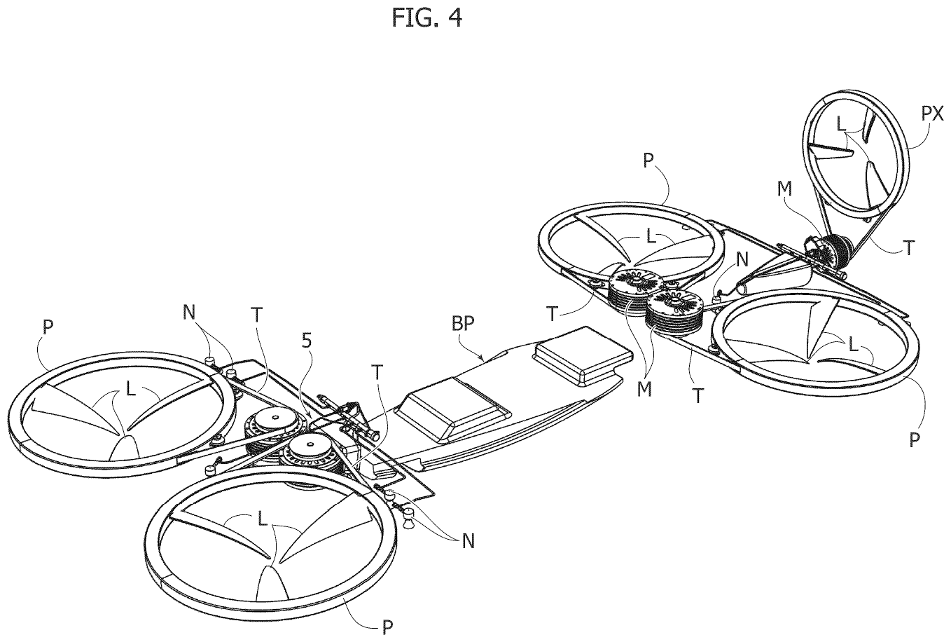

FIG. 4 is a further schematic perspective view of the system of annular propellers with which the aircraft is provided and of the corresponding driving systems;

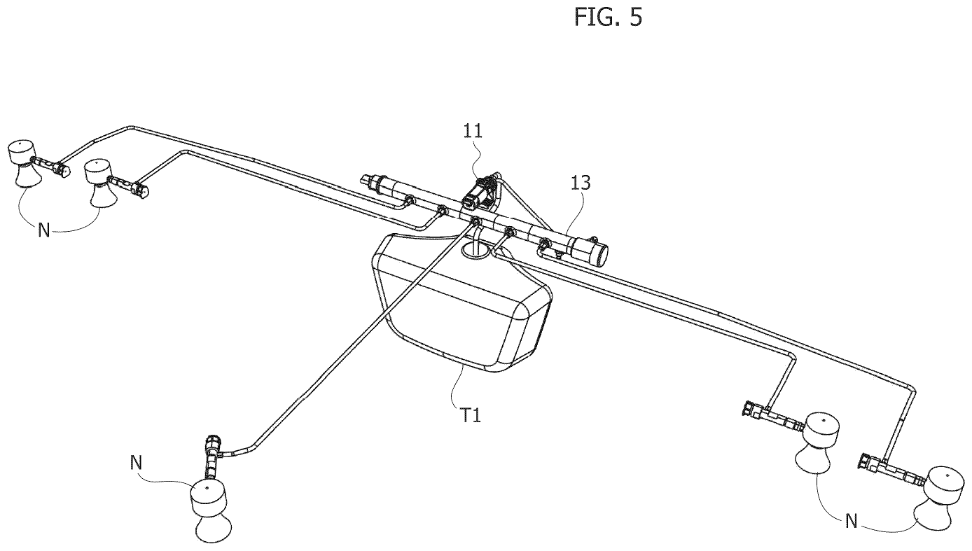

FIG. 5 is a schematic perspective view that shows only some of the nozzles with which the aircraft is provided for generating directional and/or thrust jets, together with the corresponding fuel-supply system;

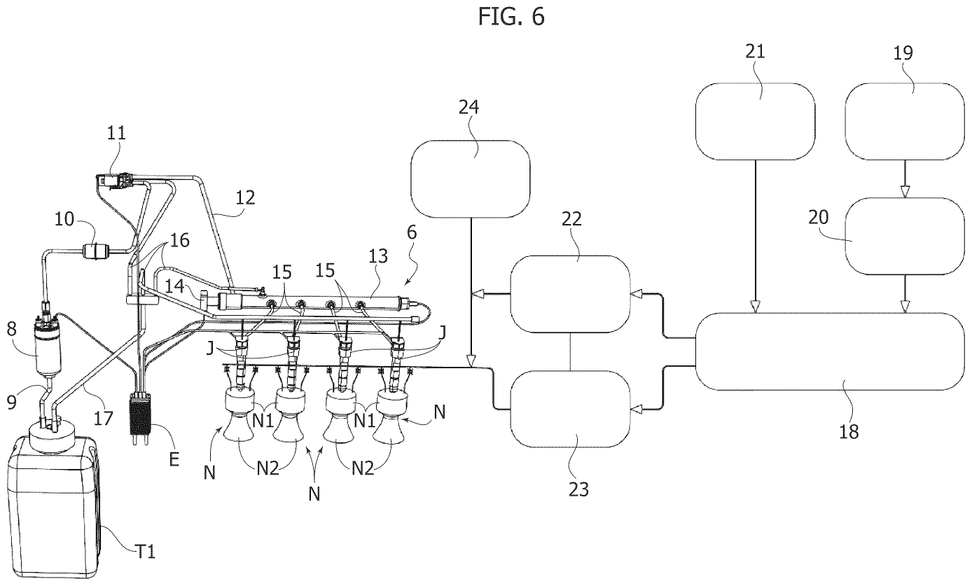

FIG. 6 is a diagram of the system for generating jets according to the invention, in a first embodiment;

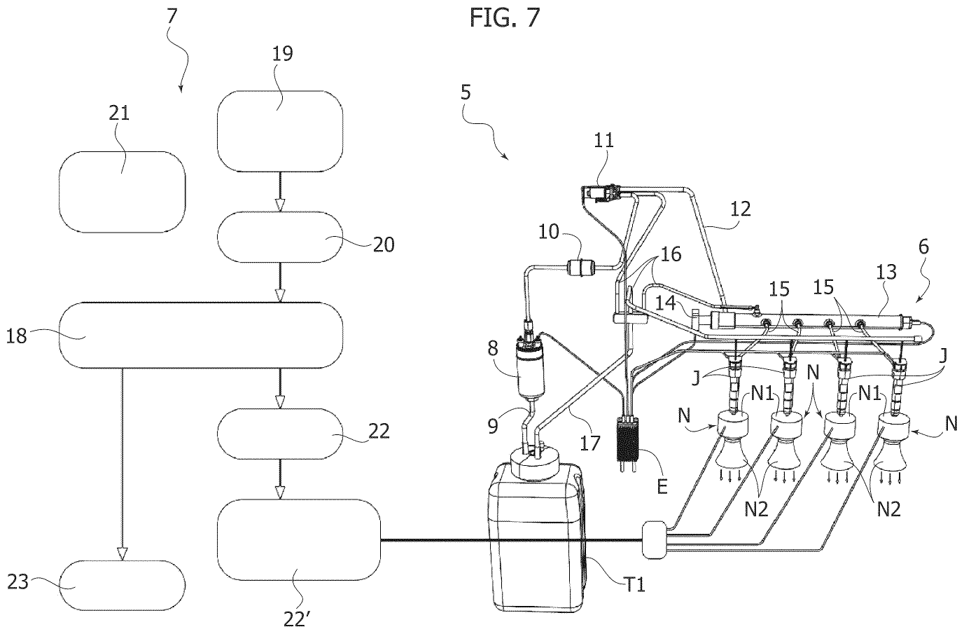

FIG. 7 is a schematic representation of a further embodiment of the system for generating jets according to the invention; and

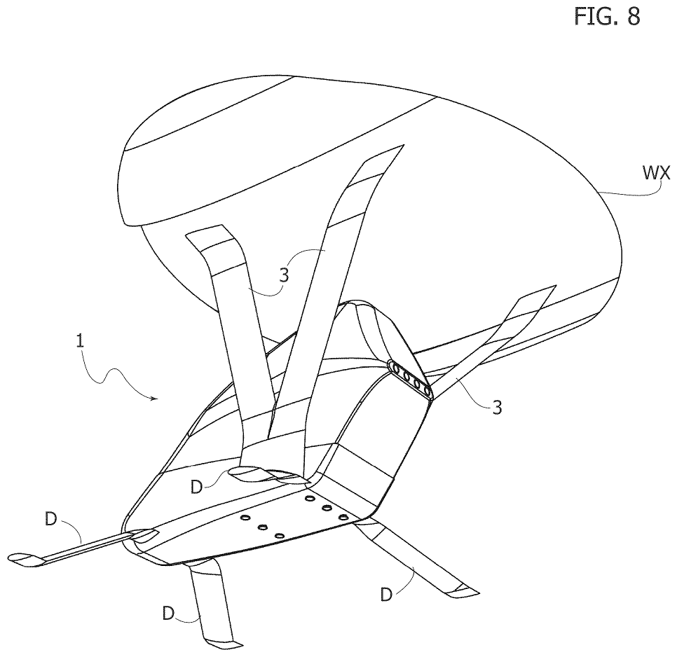

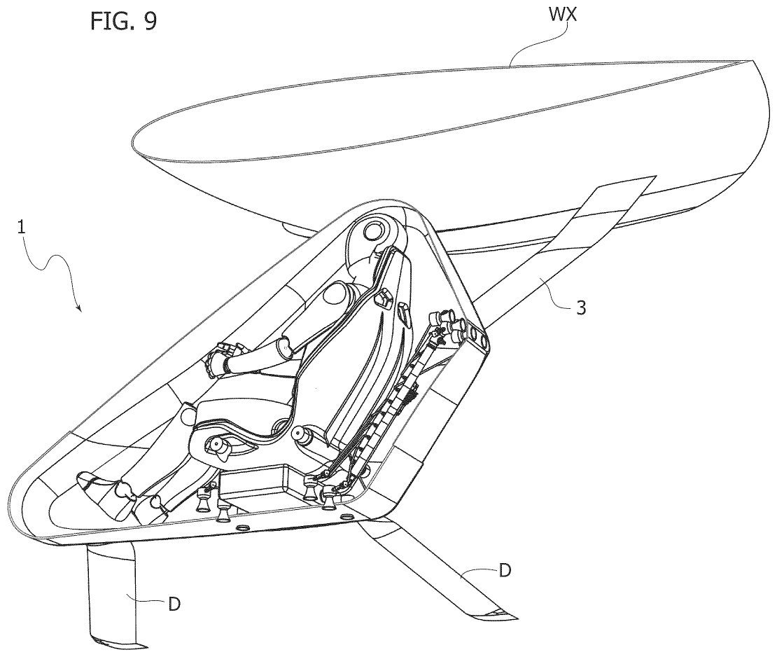

FIGS. 8 and 9 are perspective views of an ultralight aircraft constituted by just one top wing and a cockpit connected thereto in pendular mode so that the vertical and directional thrusts are obtained via the jets or via combinations of jets and annular rotors of small size.

FIGS. 1-4 show by way of example an aircraft for personal use (Personal Air Vehicle—PAV) to which the system for generating jets according to the invention can be applied. The example of aircraft illustrated in FIGS. 1-4 is in general of the type that has formed the subject of the international patent application WO 2022/200883 filed in the name of the present applicant.

The aircraft, designated as a whole by the reference 1, has a load-bearing structure 2 (see FIG. 3) constituted by a steel lattice frame defining a central body B (see, in particular, FIG. 1) that contains the cockpit C, two front wings W, and two rear wings R. The walls of the central body B and of the wings W, R are defined by sheet-steel elements rigidly connected to the lattice frame 2. Preferably, the internal cavity of the aerodynamic surfaces is filled with spongy material, preferably graphene.

In the preferred example described herein, the central body B supports on it, via arms 3, an additional wing WX having in plan view a substantially circular shape (to obtain the best aerodynamic performance in any condition of flight). The top surface of the top wing WX is also used for supporting a plurality of photovoltaic cells F, designed to generate energy that can be used for recharging the on-board electric batteries (described in detail in what follows). Also the outer surfaces of the central body B and of the wings W, R may be used for arranging photovoltaic cells thereon.

According to a solution that has formed the subject of the international patent application WO 2022/200883, arranged within the front wings Wand the rear wings R are annular propellers P, which are supported in rotation by the load-bearing structure 2 about axes that are substantially vertical (with reference to the condition where the aircraft is resting on the ground) are provided for enabling the aircraft to be sustained in flight 1. Moreover, the tail of the central body B supports a stator ring S arranged with its axis substantially parallel to the longitudinal direction of the aircraft. Rotatably mounted within the stator ring S is the rotor ring of a further annular propeller PX.

According to the prior art contained in the international patent application WO 2022/200883, each annular propeller P, PX comprises a rotor ring carrying blades L, which extend radially from the body of the rotor ring towards the axis of the rotor ring. Once again according to the prior art identified above, the rotor ring of each annular propeller P, PX is driven in rotation via a belt transmission T (see FIGS. 2 and 4) by a respective electric motor M preferably with axial flow having its axis parallel to, and set at a distance from, the axis of the rotor ring associated thereto.

With reference to FIG. 4, the electric motors M for driving the annular propellers P, PX are supplied by a battery pack BP that preferably envisages a number of independent battery packs that is redundant with respect to the strict need.

With reference once again to FIG. 1, in the example illustrated the central body B of the aircraft is equipped with bottom feet D for resting on the ground.

According to the invention, the aircraft described above is provided with a plurality of nozzles N, for example along the front wings W and in the rear part of the aircraft, for emission of directional and/or thrust jets designed to improve manoeuvrability of the aircraft in flight and/or to provide additional lift and/or thrust during flight.

FIG. 5 of the annexed drawings shows by way of example two pairs of nozzles N that are to be arranged along the front wings W of the aircraft, and a nozzle N that is to be provided in the rear part of the aircraft. In FIG. 5, the reference number 4 designates the fuel-supply system forming part of the system for generating jets according to the invention.

With reference also to FIG. 6, which shows a first example of embodiment of the system for generating the jets, each nozzle N includes a nozzle chamber N1 and an outlet mouth N2 configured in a way in itself known according to a DeLaval profile.

With reference in particular to FIG. 6, the system for generating the jets, designated as a whole by 5, comprises a system for supplying fuel at high pressure to the chambers N1 of the nozzles N, which is designated as a whole by 6, and a system for supplying a combustion-supporting fluid under pressure to the chambers N1 of the nozzles N, which is designated as a whole by the reference 7.

The fuel supplied to the chambers of the nozzles N may be of various types. In a preferred embodiment, the fuel is ammonia, or an ammonia-based mixture, but alternatively it is possible to use other fuels, including gas oil, methane, hydrogen, and mixtures that include fractions of water.

The fuel-supply system 6 includes a plurality of electromagnetically driven injector devices J, which are each associated to a respective nozzle N and are configured and provided for injecting fuel at very high pressure into the chamber N1 of the respective nozzle.

As has been mentioned above, the fuel-supply system 6 is derived from technology that is known and consolidated in the field of supply of fuel to diesel engines. Consequently, the details of construction of the components of this system, and in particular the details of construction of the injector devices J, are not described or illustrated herein in so far as they can be obtained in any known way. These constructional details, taken in themselves, do not fall within the scope of the present invention. Moreover, elimination of these details from the drawings renders the latter simpler and easier to understand.

In conformance with the typical configuration of a fuel-supply system for a diesel engine, the fuel-supply system 6 includes a fuel tank T1 containing the fuel to be supplied to the injector devices J. In the example described herein, set inside the tank T1 is an electric pump 8 having the function of supplying the fuel from the tank T1, via a connection line 9 and a filter 10, to a high-pressure pump 11 of any type known in the sphere of electronically controlled systems for supplying fuel to diesel engines. The high-pressure pump 11 is configured for supplying fuel at high pressure, via a connection line 12, to a common rail 13. An electronic controller E receives the information on the pressure existing within the common rail 13 from a pressure sensor 14 and controls the high-pressure pump 11 in such a way as to maintain the pressure inside the common rail 13 within a pre-set range of values that is such as to enable proper operation of the injector devices J. The common rail 13 is connected to the various injector devices J by means of respective ducts 14. Each injector device J, when activated by a solenoid associated thereto, injects a pre-set amount of pressurized fuel coming from the common rail 13 into the chamber N1 of the respective nozzle.

In conformance with the prior art known in the sphere of systems for supplying fuel to diesel engines, the system 6 further comprises backflow lines 16, 17 for return of excess fuel into the tank T1.

According to the invention, when a nozzle N is activated, the chamber N1 receives both fuel at high pressure from the respective injector device J and a flow of combustion-supporting fluid under pressure from the system 7 for supplying the combustion-supporting fluid. Consequently, combustion is obtained by compression that gives rise to an explosion, with consequent emission of a jet from the nozzle N.

In general, the system 7 for supplying the combustion-supporting fluid may simply comprise an air-supply system that included a compressor designed to supply a flow of air under pressure to the nozzles N.

The solution illustrated in FIG. 6 is a very specific solution, where there is envisaged a micro-electrolizer 18 that receives water from an air condenser 19 and from a water tank 20 and uses it, with the aid of electrical energy supplied by a battery 21, for generating a flow of oxygen and a flow of hydrogen that are supplied to respective tanks 22, 23. The tank 23 is used for supplying hydrogen as additional fuel directly into the chambers of the nozzles, by means of a system of valves of any known type (not illustrated) that enables selection of the nozzles that are supplied with hydrogen. At the same time, the oxygen coming from the tank 22 is supplied to the chambers of the nozzles by mixing it with compressed air coming from an air compressor 24. Also in this case, the flow of combustion-supporting fluid is supplied in a selective way to the various nozzles via a system of valves of any known type (not illustrated).

The system of FIG. 7 is substantially similar to that of FIG. 6, but in this case it is envisaged to compress directly the flow of oxygen coming from the oxygen tank 22, whereas the hydrogen generated by the micro-electrolizer is sent to a hydrogen tank without envisaging a direct supply of the hydrogen to the chambers of the nozzles. In FIG. 7, the block V represents schematically as a whole the system of valves that selectively controls the connection for supplying oxygen to the various chambers of the nozzles.

The high pressure (for example, in the region of 3000 bar) with which the fuel is injected into the chambers N1 of the nozzles N and the nebulization of the fuel obtained by means of the injector devices J, facilitates mixing with the combustion-supporting fluid and generates an explosion that produces the jet at outlet from the nozzle N.

Of course, in the case of application on an aircraft, it is possible to envisage that each nozzle N will be arranged according to a desired direction to obtain the best result in terms of control of the attitude of the aircraft. Not excluded either is the possibility of providing nozzles the orientation of which is regulated by an electro-mechanically driven actuator of any known type.

Once again in the case of the application to the aircraft, preferably two independent systems are envisaged for generating the jets, one associated to the nozzles provided in the front part of the aircraft and the other associated to the nozzles provided in the rear part of the aircraft.

Each nozzle can have a body made, for example, of nanoceramic material.

Further characteristics of the invention are the following:
A. The aircraft according to the annexed claim 1, characterized in that it comprises a sensor device for detecting the attitude of the aircraft, in particular an inertial platform, and in that the electronic controller (E) is configured for independently controlling said injector devices (J) on the basis of information obtained via said attitude sensor device.
B. The aircraft according to claim 1, characterized in that it comprises systems for generating mutually independent jets, associated, respectively, to nozzles (N) arranged in the front part of the aircraft (1) and nozzles arranged in the rear part of the aircraft (1).
C. The aircraft according to claim 1, characterized in that the load-bearing structure (2) carries a battery pack (BP) including a plurality of electric supply batteries, for supplying the electric motors (M) for driving the annular propellers (P, PX).
D. The aircraft according to claim 1, characterized in that it is equipped with a top wing (WX) having a substantially circular shape in plan view, which is supported on the central body (B) of the aircraft (1) and carries a distribution of photovoltaic solar cells (F), for generating electrical energy for recharging the electric batteries (BP) that supply the aforesaid electric motors (M) for driving the annular propellers (P, PX), the body (B) and the wings (W, R) being also preferably coated with a distribution of photovoltaic solar cells.
E. The aircraft according to claim 1, characterized in that it is equipped with a single top wing WX having a substantially circular shape in plan view connected via stays to a cockpit (FIG. 8 and FIG. 9) and wherein the jets are distributed on the bottom to provide vertical thrust and on the top side of the cockpit itself to provide horizontal thrust.

Of course, without prejudice to the principle of the invention, the details of construction and the embodiments may vary widely with respect to what has been described and illustrated herein purely by way of example, without thereby departing from the scope of the present invention, as defined in the annexed claims.

1. An aircraft for personal use or a drone, comprising:
a load-bearing structure, defining a central body with front wings and rear wings; and
a plurality of annular propellers, which are supported in rotation by the load-bearing structure about substantially vertical axes, with reference to the condition where the aircraft is resting on the ground, and are located in the front wings and in the rear wings of the aircraft, for sustaining the aircraft in flight, and at least one annular propeller supported in rotation by a tail of the central body about an axis substantially parallel to the longitudinal direction of the aircraft, to cause the aircraft to advance in flight,
wherein each annular propeller comprises a rotor ring carrying blades that extend radially from a body of the rotor ring towards an axis of the rotor ring; and
wherein each rotor ring is driven via a belt transmission by an electric motor mounted on the load-bearing structure about an axis parallel to, and set at a distance from, the axis of the respective rotor ring,
the load-bearing structure carrying a plurality of nozzles distributed along the front wings and in a rear part of the aircraft, for emission of directional jets for control of an altitude of the aircraft in flight, and/or of thrust jets designed to provide additional lift and/or thrust to
the aircraft;
each nozzle of the nozzles including a nozzle chamber and an outlet mouth for outlet of a jet of the directional jets or the thrust jets, which communicates with the nozzle chamber, and wherein the outlet mouth for outlet of the jet has a circular or elliptical cross section or is in the form of a cross-shaped slit in order to the thrust; and a system for generating jets, which includes:
a fuel-supply system for supplying pressurized fuel to each chamber of each nozzle of the nozzles; and
a system for supplying a combustion-supporting fluid under pressure to each chamber of each nozzle of the nozzles,
wherein the fuel-supply system includes:
a plurality of electromagnetically driven injector devices each associated to a respective nozzle;
a fuel tank for a fuel to be supplied to the injector devices;
an electronically controlled pump, for bringing the fuel coming from the tank to a pre-set pressure, suitable for operation of the injector devices;
a common rail, which receives pressurized fuel from the electronically controlled pump and supplies the fuel to the injector devices via respective ducts; and
an electronic controller configured for receiving information on a pressure in the common rail and for controlling said electronically controlled pump in such a way as to maintain a pressure in the common rail within a range of pre-set values, said electronic controller being configured for actuating said injector devices independently of one another to inject fuel at high pressure into the chamber of each nozzle in order to obtain a mixture with the combustion-supporting fluid that gives rise to combustion by compression, with a consequent explosion that generates a jet of fluid at high pressure at outlet from the nozzle.

2. The aircraft according to claim 1, wherein the system for supplying combustion-supporting fluid comprises a compressor having an outlet connected to the chambers of the nozzles by means of respective supply lines that include respective electrically driven valves controlled by said electronic controller.

3. The aircraft according to claim 1, wherein the fuel is chosen from among ammonia, gas oil, a mixture of ammonia and water, hydrogen, methane, or a mixture thereof, while the combustion-supporting fluid is air or oxygen.

4. The aircraft according to claim 1, wherein the system for generating the jets comprises a micro-electrolyzer configured for generating hydrogen and oxygen from water, a fuel-supply line, for supplying hydrogen obtained by means of said micro-electrolyzer to the chambers of the nozzles, and a connection line for supplying oxygen obtained by means of said micro-electrolyzer to the chambers of the nozzles.

5. The aircraft according to claim 1, wherein the load-bearing structure of the aircraft is a steel lattice frame and in that the wings of the aircraft are defined by steel sheets that coat said lattice structure, the cavity defined within said lattice structure being preferably filled with spongy material.

6. A system for generating directional and/or thrust jets, comprising:
a plurality of nozzles that each include a nozzle chamber and a jet-outlet mouth communicating with the nozzle chamber;
a fuel-supply system for supplying pressurized fuel to the each chamber of each nozzle of the nozzles; and
a system for supplying pressurized combustion-supporting fluid to each chamber of each nozzle of the nozzles, the fuel-supply system built according to fuel-injection-system technology for diesel engines and includes:
a plurality of electromagnetically driven injector devices, each device of the devices associated to a respective nozzle;
a fuel tank for the fuel to be supplied to the injector devices;
an electronically controlled pump, for bringing the fuel coming from the tank to a pre-set pressure, suitable for operation of the injector devices;
a common rail that receives pressurized fuel from the pump and supplies it to the injector devices via respective ducts; and
an electronic controller configured for receiving information on a pressure in the common rail and for controlling said pump in such a way as to keep the pressure in the common rail within a range of pre-set values, said electronic controller being configured for driving said injector devices independently of one another, to inject the pressurized fuel into the chamber of each nozzle in order to obtain a mixture with the combustion-supporting fluid that gives rise to combustion by compression, with consequent explosion that generates a jet of fluid under pressure at outlet from the nozzle.

7. The system according to claim 6, wherein the system for supplying combustion-supporting fluid comprises a compressor having an outlet connected to the chambers of the nozzles by means of respective connection lines that include respective electrically driven valves controlled by said electronic controller.

8. The system according to claim 6, wherein the fuel is chosen from among ammonia, gas oil, a mixture of ammonia and water, hydrogen, methane, or a mixture thereof, while the combustion-supporting fluid is air or oxygen.

9. The system according to claim 6, wherein the system for generating the jets comprises a micro-electrolyzer configured for generating hydrogen and oxygen from water, a fuel-supply line, for supplying hydrogen obtained by means of said micro-electrolyzer to the chambers of the nozzles, and a connection line for supplying oxygen obtained by means of said micro-electrolyzer to the chambers of the nozzles.

10. The ultralight aircraft according to claim 1, further comprising a single top wing having a substantially circular shape in plan view, which is connected via stays to a cockpit connected thereto in pendular mode and wherein the vertical and directional thrusts are obtained via the jets or combinations of jets and annular rotors of small size.
